(19) United States
(12) Patent Application Publication
(10) Pub. No.: US 2007/0186729 A1
(43) Pub. Date: Aug. 16, 2007

(54) Flush Socket Power Ratchet Tool System

(76) Inventor: David Baker, Fort Lawn, SC (US)

Correspondence Address: SCHMEISER, OLSEN & WATTS, 22 CENTURY HILL DRIVE, SUITE 302, LATHAM, NY, 12110, US

(21) Appl. No.: 11/615,879

(22) Filed: Dec. 22, 2006

Related U.S. Application Data
(63) Continuation-in-part of application No. 10/878,096, filed on Jun. 28, 2004.
(63) Continuation-in-part of application No. 10/946,015, filed on Sep. 21, 2004.

(51) Int. Cl. B25B 17/00; B25B 13/46

(52) U.S. Cl. 81/57.39

(57) ABSTRACT

A socket and a system for using the socket where the socket has a male attachment end for releaseable engagement with the female output gear of a ratchet wrench. The socket may include a coupling mechanism or a detent groove with the coupling mechanism moved to the periphery of the opening in the output gear allowing the coupling to take place within the wrench to effectively reduce the height of the socket.

### CROSS REFERENCE TO RELATED APPLICATION

This application is a continuation-in-part of U.S. application Ser. No. 10/878,096 filed on Jun. 28, 2004 and U.S. application Ser. No. 10/946,015 filed on Sep. 21, 2004, the contents of both are incorporated in their entirety.

### BACKGROUND OF THE INVENTION

1. Technical Field

The invention relates, in general, to an anvil system and method for use with pneumatic ratchet wrenches. In particular, the present invention relates to a releasably attached anvil system for use with a pneumatic ratchet, a pneumatic ratchet that includes such an anvil system, and a method of use thereof.

2. Related Art

Ratchets driven by hand or motor having sockets that append to a ratcheting drive system. The ratchet typically has a plurality of different sized sockets having a female portion to accept the male portion of the hand or motor-powered ratchet.

### SUMMARY OF THE INVENTION

The present invention offers an compact, low profile socket wherein the socket can be changed out quickly.

A first embodiment of a low profile socket configured for use with a pneumatic ratchet tool comprising: a socket having a coupling mechanism for releasable attachment of the socket to said tool, wherein at least a portion of said coupling mechanism rotates along with said socket; and a release button connected to said coupling mechanism to release said socket from said tool.

A second embodiment of a pneumatic ratchet wrench assembly comprising: a housing; a motor contained with said housing; a coupling mechanism; at least one offset gear in mechanical communication with said motor within said housing; and a rotatable socket releasably attached within said at least one offset gear with said coupling mechanism.

A third embodiment of a power ratchet flush socket tool comprising: a body having a handle portion; at least one drive attachment having a socket end and a male end; a release portion within the drive end of the drive attachment; a head portion adjacent the handle portion, the head portion comprising a head body, a first gear, and a ratchet mechanism having an output gear, wherein the output gear has an interior structure that is capable of receiving the male end of the drive attachments within the interior.

The foregoing and other features and advantages of the invention will be apparent from the following more particular description of embodiments of the invention. It is to be understood that both the foregoing general description and the following detailed description are exemplary, but are not restrictive, of the invention.

### BRIEF DESCRIPTION OF THE DRAWINGS

Some of the embodiments of this invention will be described in detail, with reference to the following figures, wherein like designations denote like members, wherein:

FIG. 1 depicts a side view of a pneumatic ratchet with a sectional view of an embodiment of the socket system, in accordance with the present invention;

FIG. 2 depicts an exploded perspective view of an embodiment of a socket and an offset gear, in accordance with the present invention;

FIG. 3A depicts a side sectional view of an embodiment of a socket, in accordance with the present invention;

FIG. 3B depicts the socket in FIG. 3A with a release button engaged, in accordance with the present invention;

FIG. 4A depicts a side sectional view of an embodiment of a socket system, in accordance with the present invention;

FIG. 4B the socket system in FIG. 4A with a release button engaged and the socket partially removed from an offset gear, in accordance with the present invention;

FIG. 5 depicts an exploded perspective view of a second embodiment of a socket and an offset gear, in accordance with the present invention;

FIG. 6A depicts a side sectional view of a second embodiment of a socket moving into engagement with an offset gear, in accordance with the present invention;

FIG. 6B depicts a side sectional view of the second embodiment of a socket system, in accordance with the present invention;

FIG. 6C depicts a side sectional view of the second embodiment of a socket disengaging from the offset gear, in accordance with the present invention;

FIG. 7 depicts an top sectional view of the second embodiment of the socket, in accordance with the present invention; and

FIG. 8 depicts a side sectional view, top view and bottom view of different sized six-point low profile sockets.

### DETAILED DESCRIPTION OF THE INVENTION

Although certain preferred embodiments of the present invention will be shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of an embodiment. The features and advantages of the present invention are illustrated in detail in the accompanying drawings, wherein like reference numerals refer to like elements throughout the drawings.

As a preface to the detailed description, it should be noted that, as used in this specification and the appended claims, the singular forms “a”, “an” and “the” include plural referents, unless the context clearly dictates otherwise.

The present invention offers an improved pneumatic ratchet for use in combination with a low profile or flush socket system that allows for the quick changing out of the socket thereby offering more flexibility and more options for the wrench user. The present invention offers greater flexibility, greater ease of use, and more options, than current pneumatic ratchets do because the lower profile socket allows access to smaller work spaces. The term pneumatic ratchet as used herein denotes an air powered hand tool to be used in conjunction with at least one rotating output that may include an anvil.

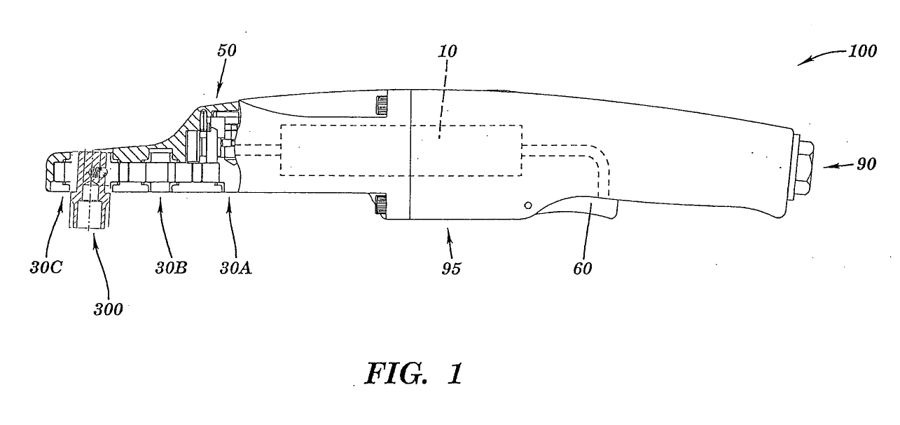

Referring to the drawings, FIG. 1 depicts a side view of a pneumatic ratchet wrench, denoted by a 100, in accordance with the present invention. The pneumatic ratchet wrench 100 includes a housing 95, a motor 10 therein, and a throttle 60, which may be in communication with the motor 10. At one end of the housing 95 may be a connector 90 for connecting the wrench 100 with an air source (not shown), such as an air compressor. At the distal end of the housing 95 may be an anvil or output system 300, a ratchet and pawl system 50, and a plurality of offset gears 30 (e.g., 30A, 30B, 30C).

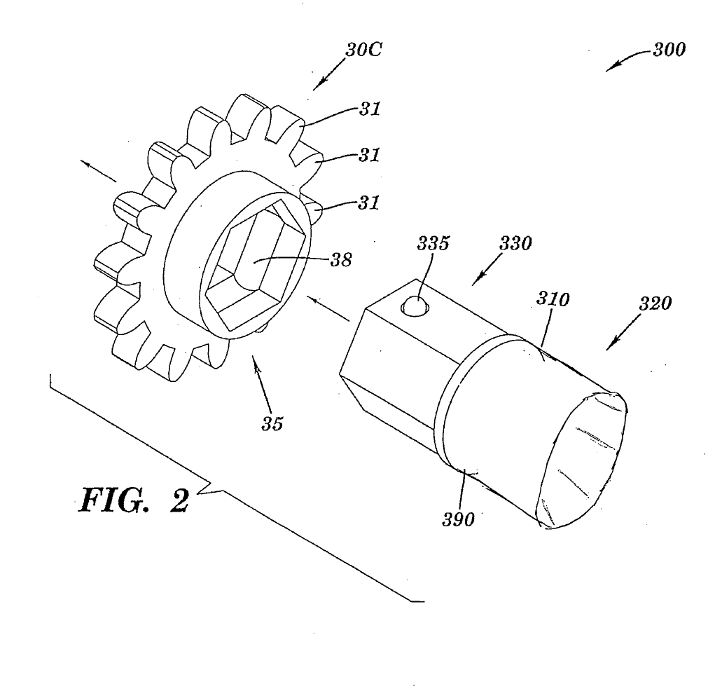

The ratchet and pawl system 50 may allow for the switching of rotational direction of a rotating anvil or output 310 (See e.g., FIG. 2). Rotation of the motor 10 may cause rotation of the plurality of offset gears 30 (e.g., 30A, 30B, 30C). Rotation of a first offset gear 30A may cause rotation of a second offset gear 30B which, in turn, causes rotation of a third offset gear 30C. The third offset gear 30C may be the most distal of the offset gears 30. Moreover, the third offset gear 30C may functionally interact with the anvil system 300 so that rotation of the third offset gear 30C causes a similar rotation in the anvil or output 310 (See e.g., FIG. 2). It is the interrelationship, in part, between the third offset gear 30C and the anvil or output 310 that forms the socket system 300 of the present invention.

Turning to FIG. 2 which shows the output or socket system 300 in exploded perspective view and the interrelationship between the third offset gear 30C and the output 310. The third offset gear 30C may include a plurality of teeth 31 interspersed on the outer circumference, which intermesh with like teeth on the second offset gear 30B. The anvil or output 310 may include a first end or socket end 320 and a drive end or second end 330. In the embodiment shown the first end 320 is a low-profile drive socket.

A coupling mechanism 335 may hold the socket 310 to the offset gear 30. The coupling mechanism is a projection that may be a ball 335 located on the socket 310 and a detent 38 located on the offset gear 30. The entire coupling mechanism may be self-contained within the socket 310 and the offset gear 30. Thus, the coupling mechanism may fully rotate in unison with the rotating socket 310 and offset gear 30. This may reduce moving parts and minimize additional bearing surfaces that are entailed in the coupling mechanism, thereby adding to the longevity of the device and lowering the total height of the socket.

In the embodiment shown, the second end 330 may be hexagonal in cross-section so as to correspond with a similarly shaped hexagonal axial opening 35 through the offset gear 30C. Located within the opening 35 in this embodiment the detent 38 may be a detent ring 38 which may communicate with a ball 335 located along the second end of the socket 310. The detent ring 38 may surround the entire circumference of the opening 35. This may allow the socket 310 to be placed within the gear 30 in virtually any rotatable configuration. The socket 310 needs only to align with the shape of the opening 35 (e.g., hexagon, square, polygon, slotted, etc.). Therefore, the socket 310 may slidingly engage with the gear 30 and lock into the gear 30 once the coupling mechanism is engaged. In the embodiment shown in FIG. 2, the socket 310 is coupled, and locked, to the gear 30 (and thus the tool 100, in whole), once the ball 335 clicks into the detent 38.

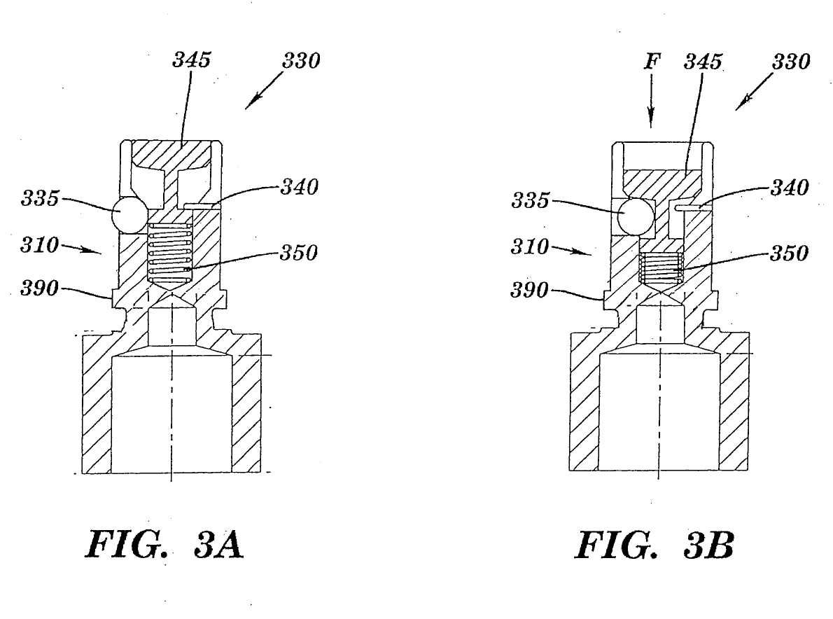

FIG. 3A depicts a side sectional view of an embodiment of the socket 310. The socket 310 may include a body 360 having a first end 320 which may be used to attach to an additional drive, or bit (not shown) or directly interact with a workpiece (not shown) and a second end 330 housing a portion of a coupling and releasing mechanism of the socket system 300. The first end 320 may include an opening to attach to a workpiece, which may be known as a socket face having any number or shape of faces for example, six, eight, ten, twelve or more faces.

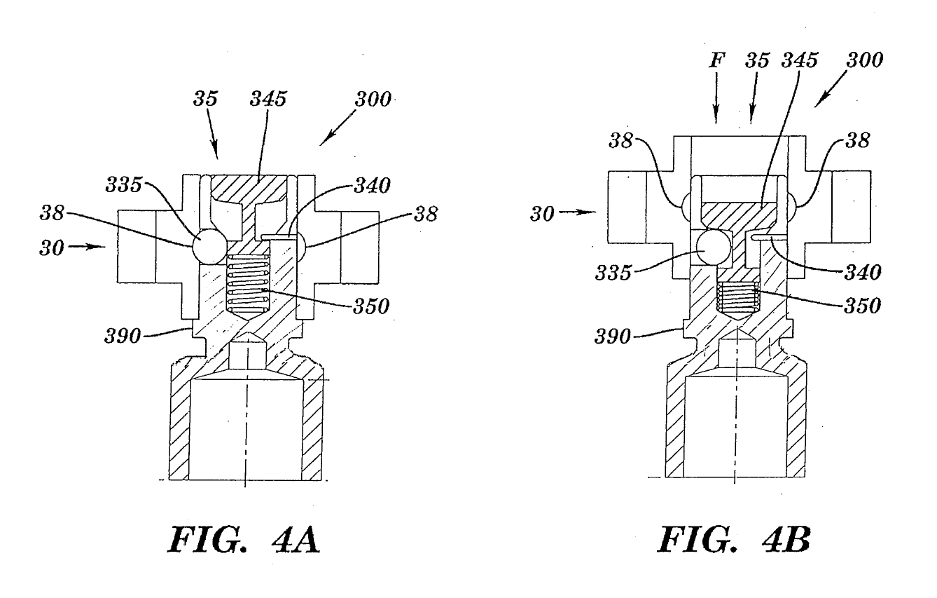

The second end 330 of the socket 310 may include a portion of the coupling and releasing mechanism that may include a release button 345 functionally attached to the body 360 by a button retention pin 340. A spring 350 or any other biasing member may provide a bias against the release button 345, while an interior portion of the release button 345 provides a normal force against ball 335. The socket 310 also may have a collar 390 to allow for seating the socket 310 against the third offset gear 30A (see FIGS. 4A and 4B). The release button 345 may be coaxial with the socket 310 and hourglass-shaped when viewed in section.

While the embodiment depicted shows the socket 310 that has a first end 320 configured to be a socket 310 instead of a typical a square drive (e.g., ¼″ drive) that typically receives a socket of various sizes, the present invention allows for the changing of the socket 310 to sockets 310 having other configurations at the first end 320. For example, other sizes (e.g., ⅝″, ⅞″, 10 mm, 18 mm etc.) for the socket 310 may be used a limited example of several size sockets 310 is shown in FIG. 8. Similarly, instead of a socket, the first end 320 may also have other shapes.

FIG. 3B depicts a side sectional view of the socket 310 (i.e., same view as FIG. 3A) only now with the release button 345 engaged, the spring 350 compressed, and ball 335 in a recessed position. A user may press, or engage, the release button 345 when they wish to remove, and change, the socket 310 from the third offset gear 30A and tool 100, in general. When a force, designated by directional arrow F, is applied to the release button 345 that is greater than the upward force provided by the bias of the spring 350, the release button 345 is displaced further into the body 360. The maximum depth that the release button 345 may be displaced further into the body 360 of the socket 310 may be determined, in part, by the button retention pin 340. Thus, when the release button 345 is displaced by force designated by directional arrow F further into the body 360, the release button 345 may no longer exert a normal force against the ball 334. As a result, the ball 335 can recess into the body 360, and the socket 310 can be removed from its seating.

FIG. 4A depicts a side sectional view of a socket 310 coupled to an offset gear 30, thereby creating a socket system 300 in accordance with the present invention. The second end 330 of the socket 310 may reside within, and may be coaxial with, the opening 35 of the offset gear 35. The seat 390 of the socket 310 may bear against, or abut, the offset gear 30. The ball 335 may ride within the detent ring 38 of the offset gear 30 thereby providing additional purchase between the socket 310 and the offset gear 35.

FIG. 4B depicts a side sectional view the low profile socket system 300 (i.e., the view in FIG. 4A) further wherein the release button 345 has been pressed so that the socket 310 is partially removed from the offset gear 30. As shown the release button 345 may be pressed downward, displaced by force designated by directional arrow F further into the body 360. As a result, the ball 335 may no longer have a normal force applied to it by the lower body portion of the release button 345. This may allow the ball 335 to recess into the body 360 of the socket 310. Thus, the ball 335 may no longer retain purchase with the detent ring 38 and the socket 310 can easily, and quickly, be released from its seating within the offset gear 30.

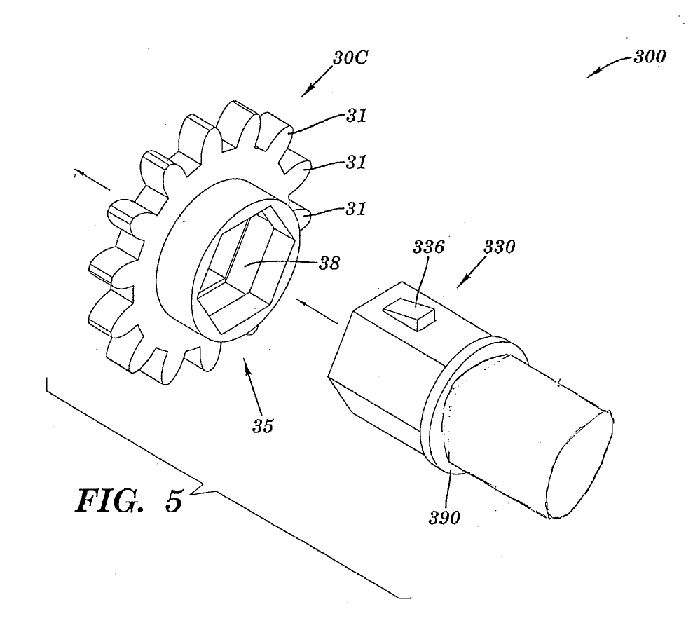

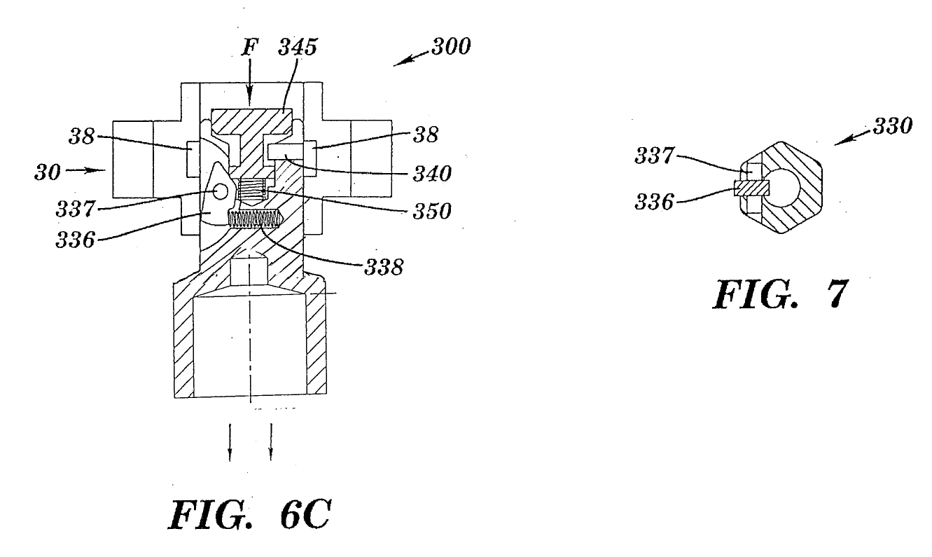

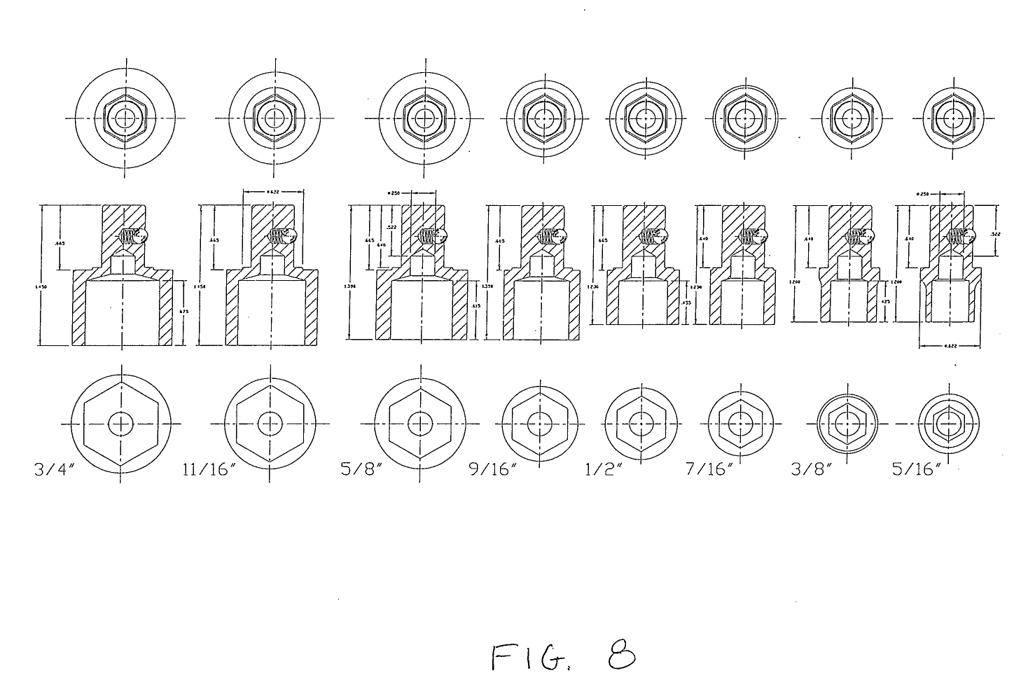

Turning to FIG. 5, which shows a second embodiment of the invention in the same perspective as depicted in FIG. 2, namely an exploded perspective view of the socket 300 and its interplay with the offset gear 30C. The socket 300, in this embodiment, may employ as part of its coupling mechanism with the gear 30, a pawl 336. Another attribute of the second embodiment may be that the release button 345 (see FIGS. 6A-6C) need not be pressed in order to install the socket 310 and engage it to the gear 30. That is the release button 345 may only need to be employed (e.g., pressed) in order to release, disengage (i.e., change) the socket 310 from the gear 30 and tool 100. Similarly though, the embodiment in FIG. 5 may include a coupling mechanism that is self-contained. Further, at least a portion of the coupling mechanism may rotate along with the socket 310.

Turning to the side elevation sections shown in FIGS. 6A through 6C, the second embodiment's details will become more apparent. FIG. 6A depicts the socket 310 as it may be pushed into releasable engagement with the offset gear 30. The pawl 336 may rotate about a pin 337 (see FIG. 7) and may be biased via a spring 338 which may reside in a recess within the socket 310. The shape of the pawl 336 may be such that the socket 310 may readily slide within the opening 35 of the gear 30. As can be seen in FIG. 6B, upon the successful mating of the socket 310 and the gear 30, a low profile socket system 300 may be created. The bias of the spring 338 may exert a lateral (i.e., outward) pressure on the pawl 336 such that the pawl 336 may rotate into the detent 38. In this embodiment the cross section of the detent 38 may be rectangular, or square, so as to provide a better purchase for the pawl 336 against the gear 30.

Similar to the views shown in FIGS. 3B and 4B, the view in FIG. 6C shows the initiation of release of the socket 310 from the gear 30. In order to remove the socket 310, a force, denoted by directional arrow F, may be exerted onto the button 345. As the button 345 is pushed further within the socket 310, a bottom portion of the button 345 may ride against the pawl 336 so that it rotates inward against the spring 338. As a result, the pawl 336 may ultimately retract within the body of the socket 310 so that the pawl 336 no longer has purchase against the detent 38. The socket 310 can then release from the gear 30.

While the embodiments shown includes some attributes, it should be apparent to those skilled in the art, that other variations, and embodiments are possible with the invention. For example, although a plurality of offset gear 30 are shown to ultimately carry the rotation of the motor 10 to the socket 310, this is not necessary. A single gear (not shown) could be the interface between the motor 10 and socket 310. Conversely, a different number of offset gears 30 could be provided. Similarly, differently mechanical interfaces entirely could be used between the socket 310 and motor 10.

Similarly, although the detent ring 38 is shown within the offset gear 30, alternative retainment means (e.g., ball 335 and detent ring 38) may be used. For example, the detent ring 38 could be fixed within another portion of the tool 100 than the offset gear 30. Alternatively, instead of a detent ring 38, a detent point or detent slot (not shown) could be used to retain the ball 335.

A rotatable socket 310 configured for use with a pneumatic ratchet tool 100 as shown in FIG. 1 may comprise a socket 310 having a coupling mechanism 335 for releasable attachment of the socket 310 to said tool 100, wherein at least a portion of said coupling mechanism 335 may rotate along with said socket 310 and may have a release button 345 that may be connected to said coupling mechanism 335 to release said socket 310 from said tool 100 as shown in FIG. 3A-4B.

The socket 310 may be low profile to allow the head portion of the tool 100 along with an appropriately sized socket 310 to fit into spaces smaller that a conventional socket system. The term low profile with a socket is meant to have the same depth to hold the workpiece, but with the area to attach the socket 310 moved within the head of the ratchet, thus effectively reducing the socket height by the length of a typical drive attachment. The coupling system may be moved from the conventional head of the conventional tool onto the socket of the invention, which may reduce the height of the combined socket and ratchet head by moving the mechanism internal to the socket. Additional benefits may include increased durability of the tool since each individual coupling mechanism on each socket 310 may undergo less usage and wear items are removed.

The coupling mechanism 335 may include a ball 335 configured to communicate with a detent 38. Alternatively, the coupling mechanism may include a pawl 336 configured to communicate with a detent 38 as shown in FIG. 5. The detent 38 may be located on an offset gear 30C in said tool 100. The coupling mechanism 335 may be self contained within said socket 310 and an offset gear 30C within said tool 100.

Another embodiment may be a pneumatic ratchet wrench assembly 100 that may comprise a housing 95 and a motor 10 contained with the housing 95. The assembly 100 may have at least one offset gear 30C in mechanical communication with said motor 10 within said housing 95. A coupling mechanism 335 within a rotatable socket 310 may releasably attach the socket 310 within the at least one offset gear 30C.

The offset gear 30C may have a female drive portion or opening 35. The rotatable socket 310 may have a drive end 330 and a workpiece end 330 of a body 310. A male head 330 may be affixed to the body 310 at said drive end 330 of said socket 310, said male head 330 dimensioned to be internally received by the female drive portion 35 of said at least one offset gear 30C.

Optionally the socket 310 may have a socket shoulder 390 at the drive end 330 of the socket body 310 adjacent the male head 330 to fully seat the socket 310 within the offset gear 30C. The socket shoulder 390 may seat against the offset gear 30C to ensure complete insertion and seating of the socket 310. Additionally a detent 38 may be positioned on the female drive portion 35 of said at least one offset gear 30C to help prevent unanticipated release of the socket 310. The male head 330, which may be affixed to the body 310 may be a hexagonal or any other desired shape. The assembly 100 may include a spring 350 loaded button 345 positioned on the male head 330. The assembly 100 may alternatively have a coupling mechanism 336 that includes a pawl 336 configured to communicate with a detent 38.

Another embodiment may be a power ratchet flush socket tool 100 that may comprise a body 95 having a handle portion 60 having a trigger. The tool 100 may include at least one drive attachment 300 having a socket end 320 and a male end 330. To aid in changing to a socket 310 that is dimensioned for a different sized workpiece a release portion 345 within the drive end 330 of the drive attachment 330 may be provided. The tool 100 may have a head portion 50 adjacent the handle portion 60, the head portion 52 comprising a head body 51, a first gear 30A, and a ratchet mechanism 50 having an output gear 30C, wherein the output gear 30C may have an interior structure 35 that is capable of receiving the male end 330 of the drive attachments 310 within the interior 35.

The drive attachment 310 may be a plurality of different sized sockets 310 in a plurality of SAE (Society of Automobile Engineers) sizes of 5/32 up to 2 inches or Metric sizes 1 to 100 mm. The male end 330 may be hexagonally shaped, square or any other shape that corresponds to the female portion. The tool 100 may have a motor 10 positioned within the housing 95. A reciprocating member 50 may be positioned at least partially within the head portion, wherein the reciprocating member 50 may be coupled to the motor 10. A ratchet mechanism 50 may be positioned at least partially within the head portion, wherein said output gear 30A may be coupled to the reciprocating member 50, wherein a pawl 50 may be coupled to the reciprocating member 50.

The tool 100 may have an opening that exposes a button 345 for attaching and releasing said socket 310 from said output gear 30C, said mechanism being self-contained. The tool 100 may have coupling mechanism 336 that may include a pawl 336 configured to communicate with a detent 38. The tool 100 may have a button 345 having an indent 340, wherein said release portion is a ball 335, wherein a portion of said ball 335 fits into said indent 340 of said button 345, as shown in FIG. 3B. A spring 350 may be provided, wherein said spring 350 is positioned within said drive end 330 of the drive attachment 310 and wherein said spring 350 may urge said button 345 to project said ball 335 partially outside of said drive attachment 310 to engage the interior structure of said output gear 38. Another method may be a button 345 that may be upwardly biased by a spring 350, wherein said release portion 336 may be a pawl 336, wherein a cam portion of said pawl 336 may rest against a portion of said button 345. To move the pawl 336 a pin 337 about which said pawl 336 pivots against a spring 338 may be provided, wherein said spring 338 may be positioned within said drive end 330 of the drive attachment 310 and wherein said spring 338 may urge said pawl 336 to project partially outside of said drive attachment 310 to engage the interior structure 35 of said output gear 30C.

Various modifications and variations of the described apparatus and methods of the invention will be apparent to those skilled in the art without departing from the scope and spirit of the invention. Although the invention has been described in connection with specific embodiments, outlined above, it should be understood that the invention should not be unduly limited to such specific embodiments. Various changes may be made without departing from the spirit and scope of the invention as defined in the following claims.

I claim:

1. A low profile socket configured for use with a pneumatic ratchet tool comprising:
a socket having a coupling mechanism for releasable attachment of the socket to said tool, wherein at least a portion of said coupling mechanism rotates along with said socket; and
a release button connected to said coupling mechanism to release said socket from said tool.

2. The socket of claim 1, wherein said coupling mechanism includes a ball configured to communicate with a detent.

3. The socket of claim 1, wherein said coupling mechanism includes a pawl configured to communicate with a detent.

4. The socket of claim 2, wherein said detent is located on an offset gear in said tool.

5. The socket of claim 3, wherein said detent is located on an offset gear in said tool.

6. The socket of claim 1, wherein said coupling mechanism is self contained within both said socket and an offset gear within said tool.

7. A pneumatic ratchet wrench assembly comprising:
a housing;
a motor contained with said housing;
a coupling mechanism;
at least one offset gear in mechanical communication with said motor within said housing; and
a rotatable socket releasably attached within said at least one offset gear with said coupling mechanism.

8. The assembly of claim 7 further comprising:
a female drive portion within said at least one offset gear;
a drive end and a workpiece end of a body of said rotatable socket; and
a male head affixed to the body at said drive end of said socket, said male head dimensioned to be internally received by the female drive portion of said at least one offset gear.

9. The assembly of claim 8 further comprising:
a socket shoulder at the drive end of the socket body adjacent the male head; and
a detent positioned on the female drive portion of said at least one offset gear.

10. The assembly of claim 8 wherein the male head affixed to the body is hexagonal.

11. The assembly of claim 9 further comprising:
a spring loaded button positioned on the male head.

12. The assembly of claim 7, wherein said coupling mechanism includes a pawl configured to communicate with a detent.

13. A power ratchet flush socket tool comprising:
a body having a handle portion;
at least one drive attachment having a socket end and a male end;
a release portion within the drive end of the drive attachment; and
a head portion adjacent the handle portion, the head portion comprising a head body, a first gear, and a ratchet mechanism having an output gear, wherein the output gear has an interior structure that is capable of receiving the male end of the drive attachments within the interior.

14. The tool of claim 13, wherein the drive attachment is a plurality of different sized sockets.

15. The tool of claim 13 wherein the male end is hexagonally shaped.

16. The tool of claim 13 further comprising:
a motor positioned within the housing;
a reciprocating member positioned at least partially within the head portion, wherein the reciprocating member is coupled to the motor;
a ratchet mechanism positioned at least partially within the head portion, wherein said output gear is coupled to the reciprocating member; and
a pawl coupled to the reciprocating member.

17. The tool of claim 13 further comprising:
a button for attaching and releasing said socket from said output gear, said mechanism being self-contained.

18. The tool of claim 13, wherein said coupling mechanism includes a pawl configured to communicate with a detent.

19. The tool of claim 13 further comprising:
a button having an indent, wherein said release portion is a ball, wherein a portion of said ball fits into said indent of said button; and
a spring, wherein said spring is positioned within said drive end of the drive attachment and wherein said spring urges said button to project said ball partially outside of said drive attachment to engage the interior structure of said output gear.

20. The tool of claim 13 further comprising:
a button upwardly biased by a spring, wherein said release portion is a pawl, wherein a cam portion of said pawl rests against a portion of said button;
a pin about which said pawl pivots; and,
a spring, wherein said spring is positioned within said drive end of the drive attachment and wherein said spring urges said pawl to project partially outside of said drive attachment to engage the interior structure of said output gear.
